(19) United States
(12) Patent Application Publication
(10) Pub. No.: US 2001/0055522 A1
(43) Pub. Date: Dec. 27, 2001

(54) Substrate processing apparatus

(75) Inventors: Masatoshi Kaneda, Kikuchi-Gun (JP); Michiaki Matsushita, Kikuchi-Gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOKYO ELECTRON LIMITED, Minato-To (JP)

(21) Appl. No.: 09/880,066

(22) Filed: Jun. 14, 2001

(30) Foreign Application Priority Data
Jun. 16, 2000 (JP) 2000-181806

(51) Int. Cl. B65G 65/00; B65G 49/07

(52) U.S. Cl. 414/217; 414/937

(57) ABSTRACT

A substrate processing apparatus is composed of: a mounting table for mounting thereon a cassette including a lid detachably attached on an opening for carrying in/out a wafer; a cassette station for processing the wafer housed in the cassette on the mounting table; a sub-arm mechanism for taking the wafer out of the cassette on the mounting table, transferring it to the cassette station, and returning the wafer after processing to the cassette on the mounting table; a partition plate for partitioning an atmosphere on the sub-arm mechanism side from an atmosphere on the mounting table side; a slide stage for moving the cassette in a direction of an opening of the partition plate on the mounting table; a lid removing mechanism for removing the lid from the opening of the cassette through the opening of the partition plate; and an X-axis cylinder for controlling a thrust of the slide stage. This can prevent a finger or the like from being caught between the cassette and the partition plate when the wafer is carried into the processing system, thereby carrying in the wafer with certainty and safety.

### BACKGROUND OF THE INVENTION

1. Field of the Invention

The present invention relates to a substrate processing apparatus with an opening between two regions for transferring a substrate between the two regions.

2. Description of the Related Art

Single wafer processing in fabrication processes of semiconductor devices has been advancing with increases in diameter of semiconductor wafers in recent years. For example, a complex processing system that resist coating processing and developing processing are performed in a single system, wafers are taken out of a cassette one by one and subjected to processing one by one, and the processed wafers are returned into the cassette one by one.

In order to prevent particles from adhering to the wafer, the coating and developing system is located in a clean room, and further down flows of clean air are formed in the processing system. Further, the system includes a cassette station for receiving the cassette and a processing section for performing processing. In this system, when the cassette is carried into the processing section from the cassette station, the cassette is mounted on a cassette stage provided in the cassette station, and the cassette stage is moved to an opening which is provided at the processing section, and then the wafers in the cassette are taken out one by one through the opening into the processing section using an arm provided in the processing section. In this case, a detachable lid is attached on an opening of the cassette to prevent particles from entering the cassette when the cassette is moved to the opening of the processing section. Therefore, when the wafer is actually taken out through the opening of the processing section, it is necessary to allow the cassette to contact a lid-facing surface of a lid removing mechanism and then remove the lid.

The above-described removal of the lid is necessarily performed in such a complex processing system, it is necessary for the cassette to contact the processing section by a predetermined thrust or more to transfer the wafer. If the cassette contacts a semiconductor processing apparatus by a thrust less than the predetermined thrust, the opening is not opened, and thus it is impossible to carry in the wafer. The greater the thrust, the more certainly the removal of the lid is performed, but excessive thrust causes safety problems. In other words, increasing the thrust too high causes an extreme danger in that a finger or the like can be caught by mistake between a wafer carrying-in/out apparatus and the semiconductor processing apparatus just before the wafer carrying-in/out apparatus contacts the semiconductor processing apparatus.

### SUMMARY OF THE INVENTION

An object of the present invention is to provide a substrate processing apparatus that realizes carrying-in or carrying-out of a substrate between two regions with certainty and high safety.

In order to attain the above-described object, the main aspect of the present invention is a substrate processing apparatus comprising: a cassette mounting table for mounting thereon a cassette having an opening for carrying in/out a substrate and including a lid detachably attached on the opening; a processing section for processing the substrate housed in the cassette on the cassette mounting table; a transfer arm mechanism for taking the substrate out of the cassette on the cassette mounting table, transferring the substrate to the processing section, and returning the substrate after processing to the cassette on the cassette mounting table; a partition member, provided between the transfer arm mechanism and the cassette mounting table, for partitioning an atmosphere on the transfer arm mechanism side from an atmosphere on the cassette mounting table side, and including an opening larger than the opening of the cassette; a cassette transfer mechanism disposed to be movable forward and backward in a direction of the opening of the partition member; a lid removing mechanism for removing the lid from the opening of the cassette through the opening of the partition member and attaching the lid to the opening of the cassette; and a thrust control mechanism for changing a thrust of the cassette transfer mechanism before and after the cassette reaches the partition member with a predetermined space therebetween.

In the present invention, the trust of the cassette transfer mechanism can be changed after the cassette transfer mechanism gets closer than the predetermined space. The thrust control mechanism preferably conducts a control to decrease the thrust of the cassette transfer mechanism where the cassette on the cassette transfer mechanism is apart from the partition member by a predetermined distance or more, and to increase the thrust of the cassette transfer mechanism where the cassette on the cassette transfer mechanism is apart from the partition member by less than the predetermined distance.

Therefore, even if a finger of an operator or the like is caught when the cassette gets closer than the predetermined space, a risk of an accident or the like is decreased because the thrust is low. In other words, the thrust is decreased when the distance between the cassette and the processing section is larger than the predetermined space, thereby securing safety even if the finger of the operator or the like is caught therebetween because the thrust is maintained low. Further, the thrust is increased from a position where the distance is smaller than the predetermined distance, making it possible to easily open the cassette opening.

It is preferable to provide a thrust switching mechanism, fixedly disposed on the cassette mounting table along a moving route of the cassette transfer mechanism, for outputting to the thrust control mechanism a signal for switching the thrust of the cassette transfer mechanism by contacting a part of the cassette transfer mechanism with the thrust switching mechanism.

According to such a configuration, the contact of a part of the cassette transfer mechanism to the thrust switching mechanism can change the thrust of the transfer mechanism between the case in which the distance between the cassette and the processing section is the predetermined distance or more and the case in which it is less than the predetermined distance, so that the thrust can be changed by a simple structure.

These objects and still other objects and advantages of the present invention will become apparent upon reading the following specification when taken in conjunction with the accompanying drawings.

### BRIEF DESCRIPTION OF THE DRAWINGS

FIG. 1 is a view showing the entire structure of a substrate processing apparatus according to an embodiment of the present invention;

FIG. 2 is a front view of the substrate processing apparatus according to the same embodiment;

FIG. 3 is a rear view of the substrate processing apparatus according to the same embodiment;

FIG. 4 is a partial perspective cross-sectional view showing a cassette removing mechanism by cutting off a part of a cassette station according to the same embodiment;

FIG. 5 is an exploded perspective view showing a cassette and a cassette lid according to the same embodiment;

FIG. 6 is a view showing a configuration of a pressurized fluid circuit for operating a slide plate according to the same embodiment;

FIG. 7 is a perspective view showing a cassette removing mechanism according to the same embodiment;

FIG. 8 is a perspective view showing a cassette removing operation according to the same embodiment;

FIG. 9 is a block cross-sectional view showing a control mechanism of the cassette removing mechanism according to the same embodiment;

FIG. 10 is a top view of the cassette station and the cassette removing mechanism according to the same embodiment;

FIG. 11 is an inside perspective view showing flows of clean air in the substrate processing apparatus according to the same embodiment;

FIG. 12 is an inside perspective view showing flows of clean air in the substrate processing apparatus according to the same embodiment;

FIG. 13 is a view showing a flow chart of the cassette removing operation according to the same embodiment;

FIG. 14 is a process cross-sectional view of the cassette removing operation according to the same embodiment;

FIG. 15 is a process cross-sectional view of the cassette removing operation according to the same embodiment;

FIG. 16 is a process cross-sectional view of the cassette removing operation according to the same embodiment;

FIG. 17 is a process cross-sectional view of the cassette removing operation according to the same embodiment;

FIG. 18 is a process cross-sectional view of the cassette removing operation according to the same embodiment;

FIG. 19 is a view showing the relation between a position of the cassette in an X-axis direction and its thrust in a cassette access operation according to an embodiment;

FIG. 20 is a plan view showing the case in which a wafer protruding from the cassette and mapping sensors of a sub-arm mutually interfere according to the same embodiment;

FIG. 21 is a perspective cross-sectional view showing a cassette removing mechanism by cutting off a part of a cassette station of a substrate processing apparatus according to a second embodiment of the present invention;

FIG. 22 is a view showing the relation between a position of a cassette in an X-axis direction and its thrust in the same embodiment;

FIG. 23 is a view showing the relation between a position of a cassette in an X-axis direction and its thrust in a modification of the present invention;

FIG. 24 is a view showing the relation between a position of a cassette in an X-axis direction and its thrust in another embodiment of the present invention;

FIG. 25 is an explanatory view of a cassette station and a cassette removing mechanism in another embodiment; and

FIG. 26 is an explanatory view of a cassette station and a cassette removing mechanism in still another embodiment.

### DETAILED DESCRIPTION OF THE PREFERRED EMBODIMENT

Hereinafter, preferred embodiments of the present invention will be described with reference to the drawings.

### First Embodiment

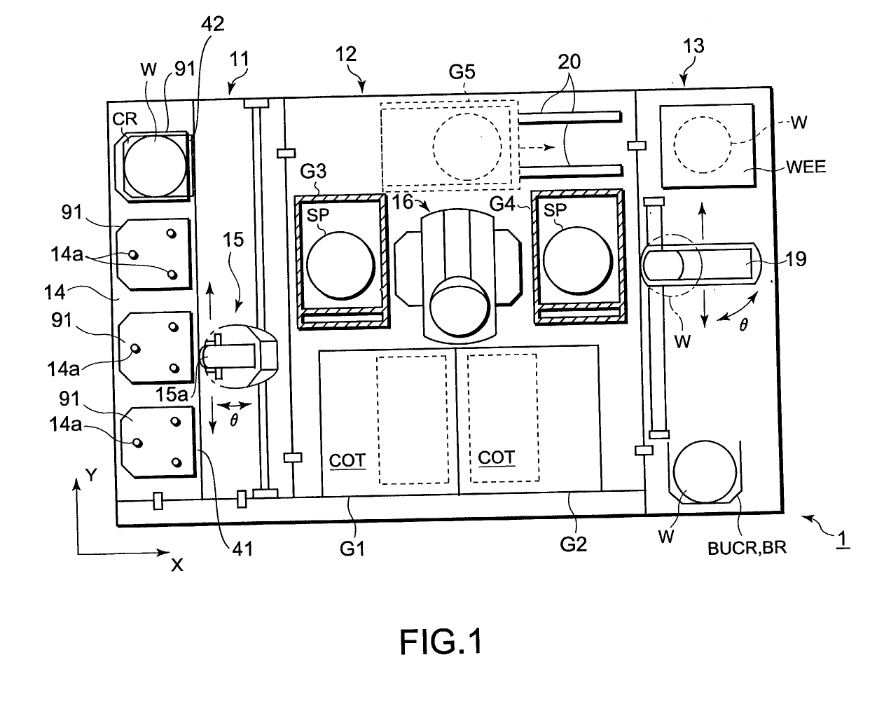

FIG. 1 is a view showing the entire structure of a coating and developing system to which a substrate processing apparatus according to an embodiment of the present invention is applied.

As shown in FIG. 1, a coating and developing system 1 includes a cassette station 11 for receiving a plurality of cassettes CR, a processing section 12 for performing resist solution coating and developing processing for a wafer W, and an interface section 13 for delivering the wafer W coated with a resist solution to/from an aligner not shown. The cassette station 11 includes a mounting table 14 to/from which the cassette CR housing, for example, 25 semiconductor wafers W, as a unit, is carried in/out, and a first sub-arm mechanism 15 for taking the wafer W out of the cassette CR.

The mounting table 14 is provided extending in a Y-axis direction so that the cassettes CR are mounted on the mounting table 14 at regular intervals. In the cassette station 11, as shown in FIG. 1, for example, four slide stages 91 as cassette transfer mechanisms are arranged on the mounting table 14, so that when a cassette CR is mounted on each slide stage 91, the cassette CR is positioned by three projections 14a with its wafer port 41 facing the processing section 12 side.

The first sub-arm mechanism 15 can deliver the wafer W to a main arm mechanism 16 in the processing section 12, and is also accessible to an alignment unit (ALIM) and an extension unit (EXT) which are included in multi-tiered units of a third processing unit group G3 on the processing section 12 side described below.

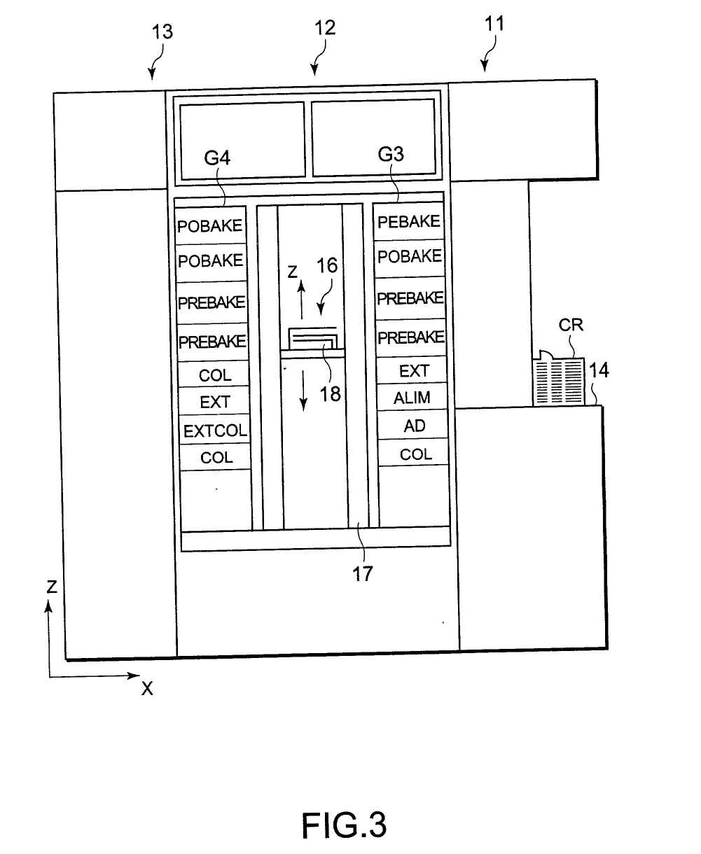

The delivery of the wafer W between the cassette station 11 and the processing section 12 is performed via the third processing unit group G3. This third processing unit group G3 is constituted by stacking a plurality of processing units in a vertically multi-tiered form as shown in FIG. 3. More specifically, this processing unit group G3 is constituted by stacking in order from the bottom to the top, for example, a cooling unit (COL) for performing cooling processing for the wafer W, an adhesion unit (AD) for performing hydrophobic processing to enhance adherence of the resist solution to the wafer W, the alignment unit (ALIM) for positioning the wafer W, the extension unit (EXT) for allowing the wafer W to wait therein, two pre-baking units (PREBAKE) each for heating a resist film before exposure processing, a post-baking unit (POBAKE) for performing a heat treatment for the wafer W after developing processing, and a post-exposure baking unit (PEBAKE) for performing a heat treatment after exposure processing.

The delivery of the wafer W to the main arm mechanism 16 is performed via the extension unit (EXT) and the alignment unit (ALIM).

Further, around this main arm mechanism 16, first to fifth processing unit groups G1 to G5 including the third unit group G3 are provided to surround the main arm mechanism 16 as shown in FIG. 1. As in the above-described third processing unit group G3, the other processing unit groups G1, G2, G4 and G5 are also structured by stacking various kinds of processing units in a vertical direction.

On the other hand, the main arm mechanism 16 is, as shown in FIG. 3, provided with a main arm 18 to be ascendable and descendable in a vertical direction (a Z-direction) inside a cylindrical guide 17 which extends in the vertical direction. The cylindrical guide 17 is connected to a rotating shaft of a motor (not shown) to rotate integrally with the main arm 18 around the rotating shaft by a rotary driving force of the motor, whereby the main arm 18 is rotatable in a θ-direction. Incidentally, the cylindrical guide 17 may be configured to connect with another rotating shaft (not shown) which is rotated by the aforementioned motor. The main arm 18 is moved in the vertical direction as described above, thereby allowing the wafer W to get access to any of the processing units of the processing unit groups G1 to G5.

The main arm mechanism 16, which receives the wafer W from the cassette station 11 through the extension unit (EXT) of the third processing unit group G3, first carries the wafer W into the adhesion unit (AD) of the third processing unit group G3, where hydrophobic processing is performed. Then, the wafer W is carried out of the adhesion unit (AD) and subjected to cooling processing in the cooling unit (COL).

The wafer W which has been subjected to the cooling processing is positioned to face and carried into a resist solution coating unit (COT) of the first processing unit group GI (or the second processing unit group G2) by the main arm mechanism 16.

The wafer W coated with the resist solution is unloaded by the main arm mechanism 16 and delivered through the fourth processing unit group G4 to the interface section 13.

This fourth processing unit group G4 is, as shown in FIG. 3, constituted by stacking in order from the bottom to the top a cooling unit (COL), an extension and cooling unit (EXT . COL), an extension unit (EXT), a cooling unit (COL), two pre-baking units (PRFEBAKE) and two post-baking units (POBAKE).

The wafer W taken out of the resist solution coating unit (COT) is first inserted into the pre-baking unit (PREBAKE) and dried by evaporating a solvent (thinner) from the resist solution. It should be noted that the drying may be performed by, for example, a pressure reducing method. More specifically, the drying may be performed by a method that the wafer W is inserted into the pre-baking unit (PREBAKE) or a chamber that is provided separately therefrom, and a pressure around the wafer W is reduced to thereby remove the solvent (dry the resist solution).

Then, the wafer W is cooled in the cooling unit (COL) and thereafter delivered through the extension unit (EXT) to a second sub-arm mechanism 19 which is provided in the aforementioned interface section 13.

The second sub-arm mechanism 19 which receives the wafer W houses in sequence the received wafer W into a buffer cassette BUCR. The interface section 13 delivers the above wafer W to the not shown aligner and receives the wafer W after exposure processing.

The exposed wafer W is delivered to the main arm mechanism 16 through the operation reverse to the aforementioned after its unnecessary resist film at the wafer peripheral portion (for example, 1 mm) is exposed to light in an edge exposure unit (WEE). The main arm mechanism 16 inserts the exposed wafer W into the post-exposure baking unit (PEBAKE) to allow the wafer W to be subjected to a heat treatment and thereafter cooling processing at a predetermined temperature in the cooling unit (COL). The main arm mechanism 16 then inserts the wafer W into the developing unit (DEV) to allow the wafer W to be subjected to development. The wafer W after the developing processing is transferred to any of the post-baking units (POBAKE) and dried by heating there, and then transferred through the extension unit (EXT) of the third processing unit group G3 to the cassette station 11 and housed in the cassette CR.

Incidentally, the fifth processing unit group G5 is selectively provided and configured similarly to the fourth processing unit group G4 in this embodiment. Further, the fifth processing unit group G5 is held to be movable by rails 20, facilitating performance of maintenance processing for the main arm mechanism 16 and the first to fourth processing unit groups G1 to G4.

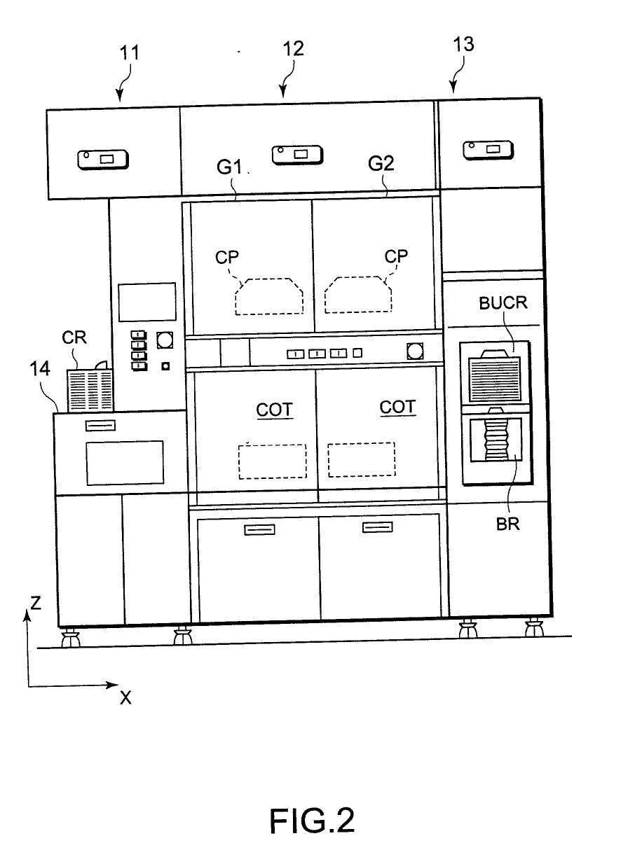

In the case in which the substrate processing apparatus of the present invention is applied to the coating and developing system shown in FIG. 1 to FIG. 3, the processing units are vertically stacked one upon another, thereby considerably reducing the footprint of the apparatus.

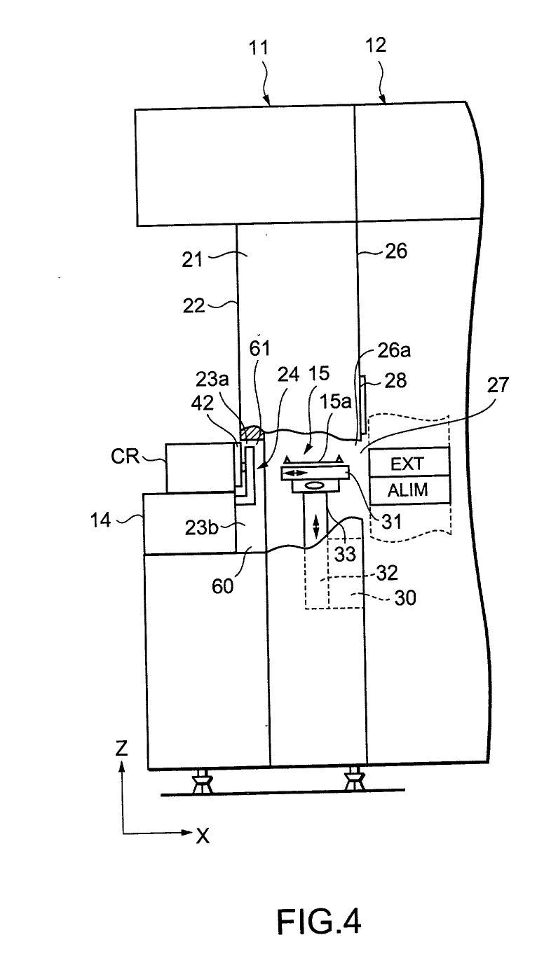

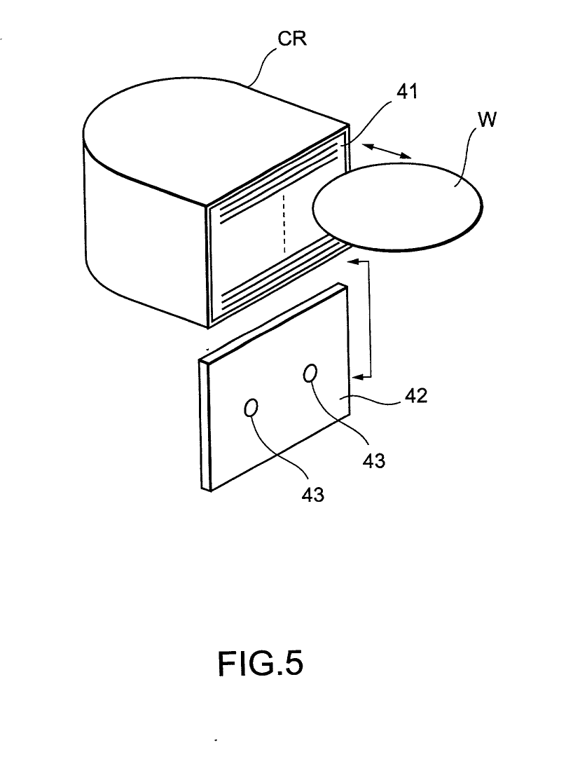

Next, the substrate processing apparatus of the present invention is explained referring to FIG. 4 and FIG. 5.

FIG. 4 is a partial perspective cross-sectional view showing a cassette lid removing mechanism of this embodiment by cutting off a part of the cassette station 11, and FIG. 5 is an exploded perspective view showing the cassette CR and its lid. As shown in FIG. 4, a transfer chamber 21 of the cassette station 11 is partitioned from a clean room atmosphere by a first vertical partition plate 22. The vertical partition plate 22 is made of, for example, an acrylic plate or stainless steel.

The first vertical partition plate 22 is formed with, for example, four openings 23a. In the opening 23a, a lid removing mechanism 24 is provided. The lid removing mechanism 24 removes a lid 42 from the cassette CR in a path 27. The lid 42 removed from the cassette CR is temporarily housed in a lid housing 23b that is provided below the opening 23a. Further, the opening 23a provided in the first vertical partition plate 22 is closed by a shutter plate 61 during non-processing. The shutter plate 61 moves in the Z-axis direction, thereby closing and opening the opening 23a.

The cassette station 11 and the processing section 12 are partitioned by a second vertical partition plate 26. The second vertical partition plate 26 is provided with an opening 26a. An atmosphere in the cassette station 11 communicates with an atmosphere in the processing section 12 through this opening 26a. In a space between the first and second vertical partition plates 22 and 26, the path 27 is formed which leads to this opening. Further, the second vertical partition plate 26 is equipped with an opening/closing shutter 28. This shutter 28 moves in the Z-axis direction, thereby opening and closing the opening 26a of the second vertical partition plate 26. The opening 26a is opened while the cassette CR is mounted on the mounting table 14 and closed while no cassette CR is mounted on the mounting table 14. A horizontal cross-sectional area of the path 27 is slightly greater than the opening of the cassette CR.

In the path 27, the first sub-arm mechanism 15 is provided. The first sub-arm mechanism 15 comprises an X-axis drive mechanism 31 for moving an arm 15a in the X-axis direction, a Y-axis drive mechanism 30 for moving the arm 15a in the Y-axis direction, a Z-axis drive mechanism 32 for moving the arm 15a in the Z-axis direction, and a θ-rotation drive mechanism 33 for rotating the arm 15a around the Z-axis. This first sub-arm mechanism 15 takes the wafer W out of the cassette CR through the path 23a of a gate block 60, and further carries the wafer W into the processing section 12 through the opening 26a of the second vertical partition plate 26.

As shown in FIG. 5, the opening 41 is formed at the front face of the cassette CR, so that the wafer W is carried into/out of the cassette CR through the opening 41. The opening 41 is covered with the lid 42 to keep the inside of the cassette CR airtight. For example, the inside of the cassette CR is filled with a nonoxidizing gas such as N₂ gas. Alternatively, it is also preferable to provide an N₂ gas filling means at the mounting table 14 to replenish and fill N₂ gas or the like into the cassette CR of which the wafer W will be taken out. Further, two key holes 43 are formed in the front face of the lid 42. The positions of the two key holes 43 are prescribed by SEMI standard.

As shown in FIG. 4, four lid housings 23b are provided in a row in the Y-axis direction on the side face of the mounting table 14 on the transfer chamber 21 side. The lid housing 23b is a space for housing therein the lid 42 which is removed from the cassette CR.

On the other hand, the four lid removing mechanisms 24 provided in the transfer chamber 21 are provided to correspond to the lid housings 23b so as to remove the lids 42 from the cassettes CR and house them in the lid housings 23b thereunder.

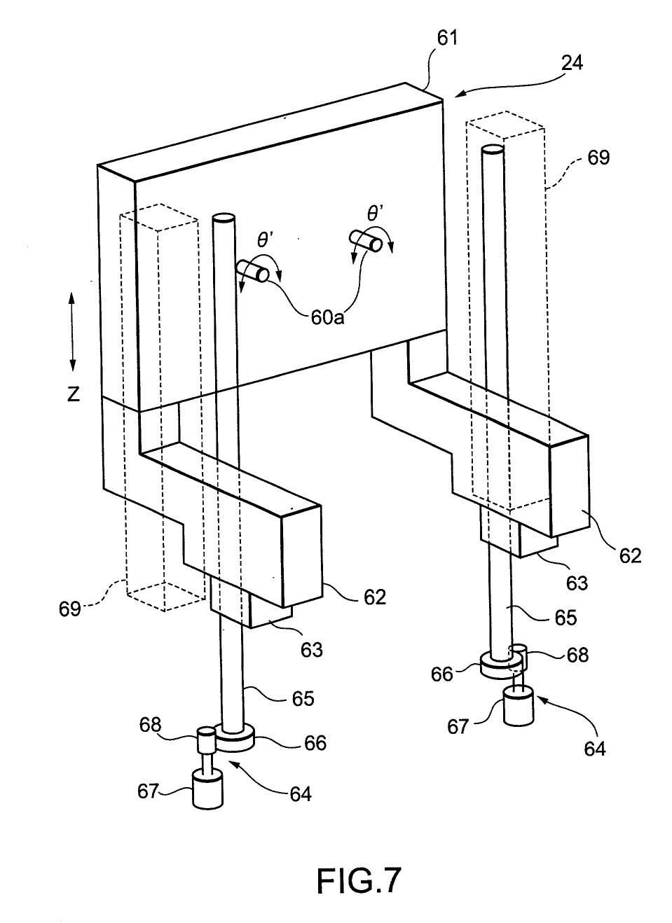

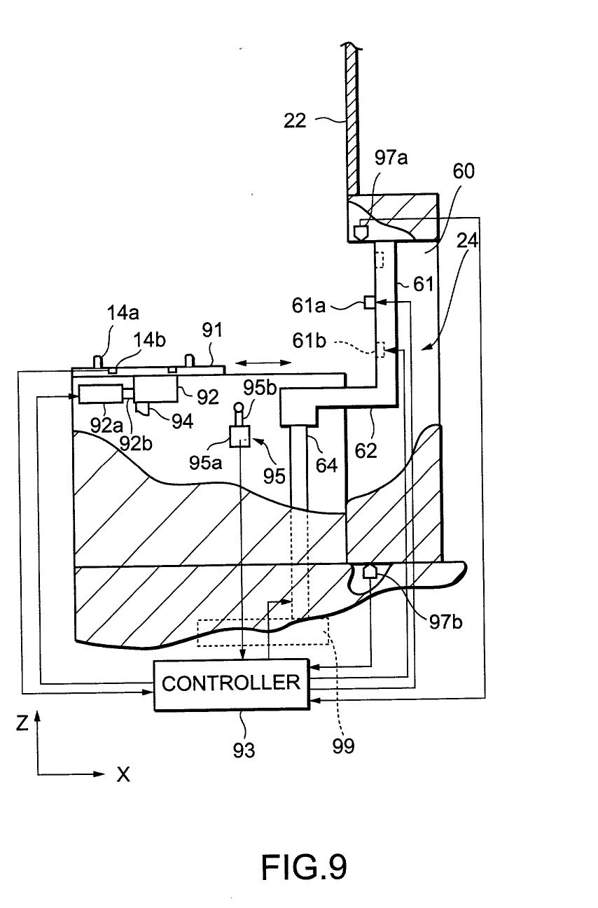

Next, the lid removing mechanism 24 is explained with reference to FIG. 7 and FIG. 9.

The lid removing mechanism 24 includes a shutter plate 61. The shutter plate 61 is supported by support members 62. The support members 62 are provided with two openings not shown piercing in the Z-axis direction. For example, nuts 63 are attached to these two openings. The nuts 63 are screwed into ball screws 65 of raising and lowering mechanisms 64, and gears 66 of the ball screws 65 engage with driving gears 68 of motors 67. Further, for example, nuts (not shown) are attached on both right and left ends of the support members 62, and the nuts (not shown) are linked to linear guides 69 respectively. The shutter plate 61 is moved in the Z-axis direction in the space from the path 23a to the lid housing 23b by the above-described raising and lowering mechanism 64. Incidentally, it is possible to employ an air cylinder for the raising and lowering mechanism 64. Further, the raising and lowering mechanisms 64, which are associated with the two support members 62 provided on both sides of the shutter plate 61, are synchronously controlled by a controller 93. Furthermore, the shutter plate 61 is configured to be movable in the X-axis direction by an X-axis drive mechanism 99 when the lid 42 is removed.

The cassette CR is mounted on the slide stage 91 that slides in the X-axis direction on the mounting table 14.

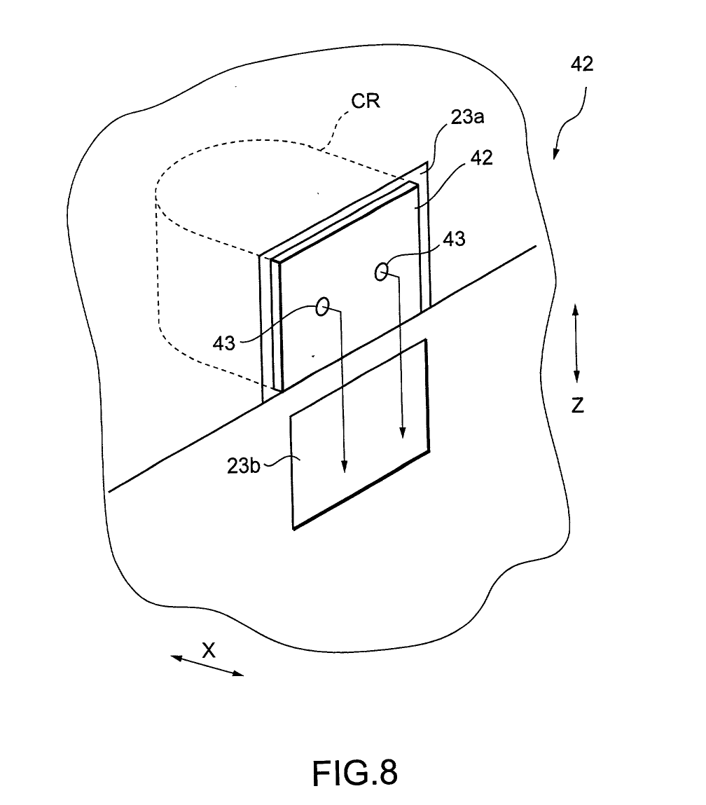

FIG. 8 is a view showing an operation of removing the cassette lid with the lid removing mechanism omitted. The shutter plate 61 of the lid removing mechanism 24 slightly moves in the X-axis direction by a Z-axis drive mechanism (not shown) to remove the lid 42 from the cassette CR, and further moves in the Z-axis direction while holding the lid 42, thereby moving the lid 42 of the cassette CR to the lid housing 23b which is shown by arrows.

FIG. 9 is a block diagram showing optical sensors 97a and 97b each for detecting the front end of the cassette or a wafer protruding from the cassette, and the slide stage 91 for moving the cassette CR to a lid removing position.

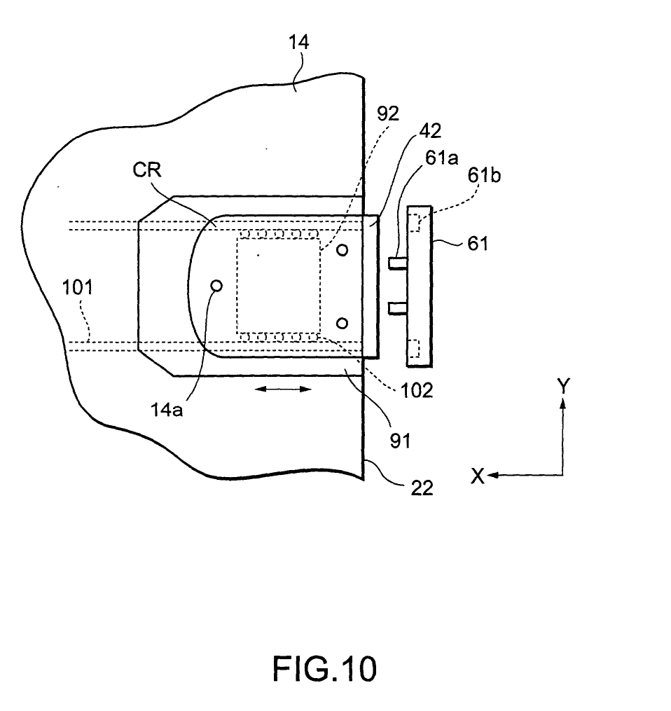

The cassette mounting table 14 is provided with a movable base 92 which is linked to a rod 92b of an X-axis cylinder 92a. The movable base 92 is fixed to the lower face of the slide stage 91, whereby the slide stage 91 and the movable base 92 are integrally constituted. The projections 14a are provided at the center of the upper face of the slide stage 91. When a cassette CR is placed on the slide stage 91, the projections 14a fit in bottom recesses (not shown) of the cassette CR to position the cassette CR. Sensors 14b are provided near the projections 14a to face them respectively so as to detect the cassette CR when it is placed on the slide stage 91 and send their detection signals to the controller 93 by their touch sensor functions. Further, a s shown in the plan view of FIG. 10, linear guides 101 are provided on both sides of the movable base 92 with predetermined gaps interposed with respect to the movable base 92 respectively, and ball members 102 are sandwiched therebetween. The linear guides 101 and the ball members 102 enable linear movement in the X-axis direction of the movable base 92 and the slide stage 91.

A switching drive piece 94 is attached on the lower face of the movable base 92. The switching drive piece moves with the linear movement in the X-axis direction of the movable base 92. In a course of the drive piece 94, a thrust switching mechanical valve 95 is fixedly provided at , for example, the linear guide 101. The thrust switching mechanical valve 95 comprises a lever switching valve 95a and a switching lever 95b. The switching lever 95b is provided standing at the lever switching valve 95a, so that a force is applied to the switching lever 95b in the lateral direction thereof to tilt it. In this embodiment, when the switching drive piece 94 linearly moves in the X-axis direction and reaches a predetermined position, the switching drive piece 94 contacts the switching lever 95b. Then, the contact applies a force in the lateral direction of the switching lever 95b to tilt the switching lever 95b, thereby switching the thrust by the X-axis cylinder 92a. The predetermined position here refers to a position where the lid 42 of the cassette CR approaches to within, for example, 5 mm to 20 mm apart from the vertical partition plate 22 or, more preferably, to within a position 10 mm to 15 mm a part. This position means that the distance between the lid 42 and the vertical partition plate 22 substantially has no risk that a finger of an operator can be caught therebetween, and the width of the space can be changed as required in accordance with using conditions or the like. Incidentally, the relative position of the cassette CR with respect to the vertical partition plate 22 where there is substantially no danger in that the finger of the operator can be caught therebetween is called “a second position” in the explanation below.

The optical sensors 97a and 97b are provided on the top and the bottom of the gate block 60 respectively so that their optical axes cross the front face of the cassette CR which is at a third position. Incidentally, “a third position” refers to a position of the cassette CR where the lid 42 is removed from the cassette CR and a position of the cassette where the wafer W is taken out of the cassette CR from which the lid 42 has been removed. Further, “a first position” refers to an initial position of the cassette CR when the cassette CR is mounted on the slide stage 91 and positioned.

The controller 93 is configured to control operations of the X-axis cylinder 92a and a motor 55 of the lid removing mechanism 24 based on detection information sent from the sensor 14b and the optical sensors 97a and 97b respectively.

The shutter plate 61 has a pair of keys 61a, which are supported by a θ′-rotation drive mechanism (not shown) respectively. The keys 61a are attached on the shutter plate 61 to face the key holes 43 in the cassette lid 42 shown in FIG. 5 respectively. The keys 61a are inserted into the key holes 43 and θ′-rotated, lock pieces (not shown) fall into key grooves of the key holes 43, thereby locking the cassette lid 42 to the shutter plate 61.

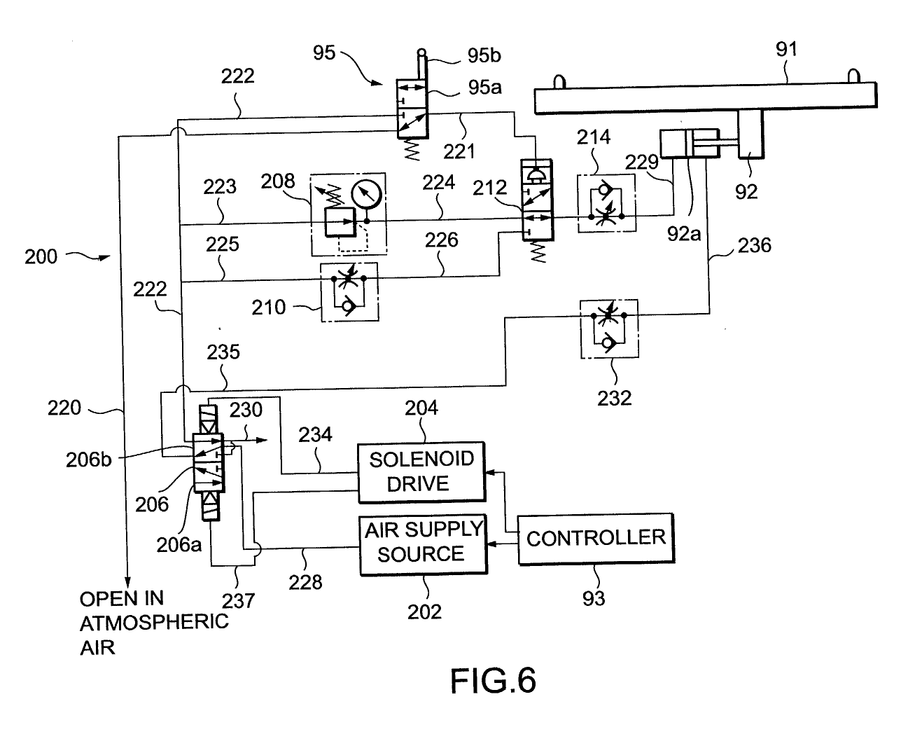

Next, a pressurized fluid circuit for operating the slide stage 91 is explained as one embodiment referring to FIG. 6.

A circuit 200 is of using air from an air supply source 202 as a pressurized fluid and comprises a docking circuit for a docking-in operation of causing the cassette CR to contact the opening 23a which is an opening portion of the cassette station 11 and an undocking circuit for a docking-out operation of causing the cassette CR to retreat therefrom.

The docking circuit is explained first. One end of a line 220 communicates with a side port of the lever switching valve 95a of the thrust switching mechanical valve 95 and the other end thereof is open in the atmospheric air. A downstream side line 221 from the lever switching valve 95a communicates with a slide head port of a pressure switching valve 212. Two upstream side lines 224 and 226 and one downstream side line 229 communicate with side ports of the pressure switching valve 212 respectively. The downstream side line 229 from the pressure switching valve 212 communicates with one inner chamber of the X-axis cylinder 92a. The line 229 is provided with a speed control valve 214 with a check valve . The one upstream side line 224 is provided with a pressure (driving pressure) control valve 208 with a pilot circuit, and the other upstream side line 226 is provided with a speed control valve 210 with a check valve .

An upstream side line 223 from the pressure control valve 208 and an upstream side line 225 from the speed control valve 210 join a line 222 at a further upstream side. Conversely, the line 222 branches out to the two lines 223 and 225. The joined line 222 communicates with a side port of a solenoid valve 206. Another side port of the solenoid valve 206 communicates with an exhaust line 230. The exhaust line 230 is an exhaust route on the other side of the drive side of the X-axis cylinder 95a. Further, another side port of the solenoid valve 206 communicates with the air supply source 202 through a line 228. A drive circuit (not shown) of the air supply source 202 is connected to an output of the controller 93, so that the operation of the air supply source 202 is controlled in accordance with predetermined initial input conditions and detection information from the sensors.

An inner circuit of the lever switching valve 95a is switched by the lever 95b, so that while the lever 95b stand s, the port of the pressure switching valve 212 communicates with the line 224 to supply air at a low pressure (for example, about 0.05 MPa) into the inner chamber of the X-axis cylinder 92a. On the other hand , while the lever 95b is tilted, the port of the pressure switching valve 212 communicates with the line 226 to supply air at a high pressure (for example, about 0.35 MPa) into the inner chamber of the X-axis cylinder 92a. As for the solenoid 206, a solenoid 206b is connected to the port when voltage is applied to a signal line 234 extending from a solenoid drive 204, and a solenoid 206a is connected to the port when voltage is applied to a line 237.

Next, the undocking circuit is explained. The solenoid drive 204 of which the operation is controlled by the controller 93 switches on the solenoid 206b of the solenoid valve 206 through the line 234 to communicate the solenoid 206b with the port. The other port of the solenoid 206b of the solenoid valve 206 communicates with a line 236 through a line 235 and via a speed control valve 232 with a check valve . Further, the line 236 communicates with the other inner chamber of the X-axis cylinder 92a.

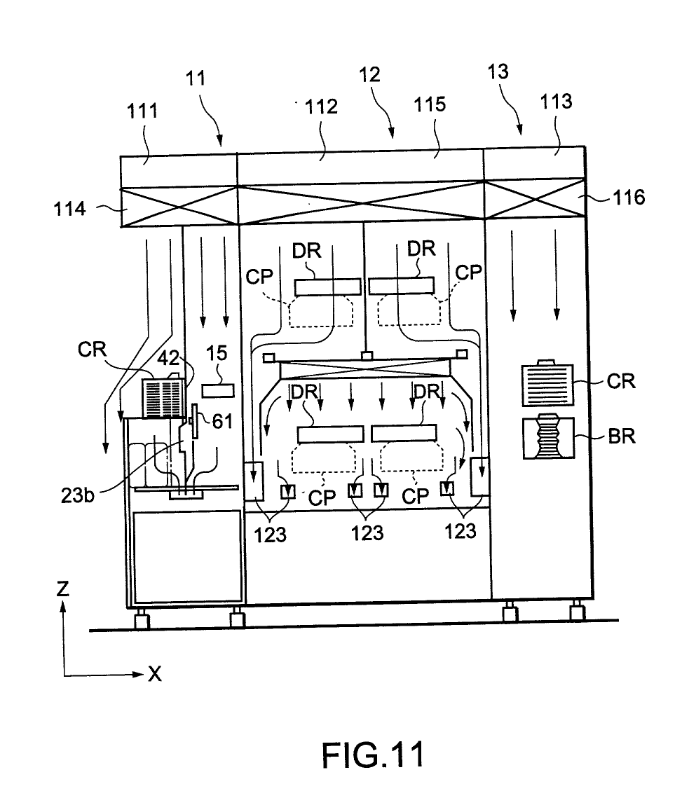

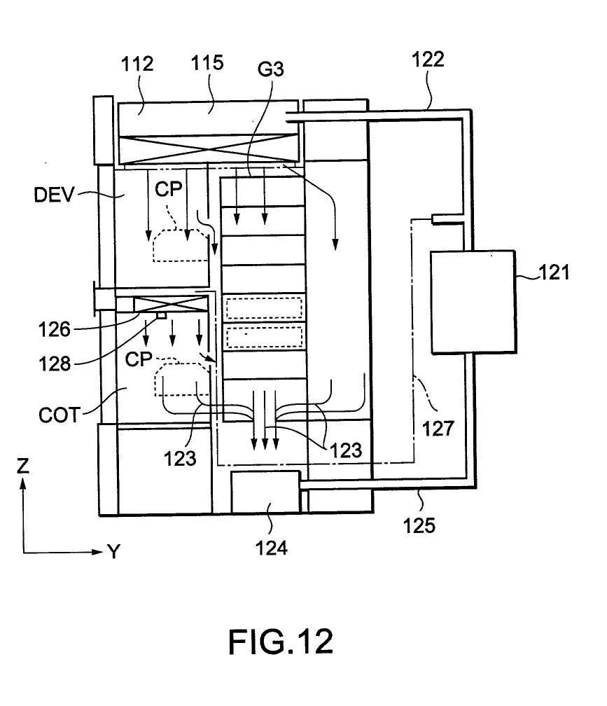

The aforementioned coating and developing system 1 is installed in a clean room in which down flows of clean air are formed. The flows of the clean air in the system 1 are explained using FIG. 11 and FIG. 12. As shown in FIG. 11, down flows of clean air are independently formed also inside the system 1, thereby improving the degrees of cleanliness in the station and sections of the processing system 1. In the system 1, air supply chambers 111, 112 and 113 are provided at the top of the cassette station 11, the processing section 12 and the interface section 13. On the lower face s of the air supply chambers 111, 112 and 113, ULPA filters 114, 115 and 116 are attached each having a dust proof function.

Further, as shown in FIG. 12, an air conditioner 121 is installed at the outside or the back of the processing system 1, so that the air conditioner 121 introduces air through a piping 122 into the air supply chambers 111, 112 and 113 to supply clean air in down flows from the ULPA filters 114, 115 and 116 to the station and sections 11, 12 and 13. The air in down flows is gathered through a plurality of air holes 123 which are provided at proper points at the lower portion of the system into an exhaust port 124 at the bottom, and passes from the exhaust port 124 through a piping 125 to be collected into the air conditioner 121.

In the processing section 12, ULPA filters 126 are provided at the ceiling face s of the resist coating units (COT), (COT) which are disposed at the lower tiers of the multi-tiered units of the first and second groups G1 and G2, so that the air from the air conditioner 121 is sent to the ULPA filters 126 through a piping 127 which branches out from the piping 122. A temperature and humidity regulator (not shown) is provided along the piping 127 to supply to the resist coating units (COT), (COT) clean air at predetermined temperature and humidity suitable for the resist coating step. Further, a humidity and temperature sensor 128 is provided near the outlet side of the ULPA filter 126, so that a sensor output is provided to a controller of the temperature and humidity regulator to accurately control the temperature and humidity of clean air by a feed-back method.

In FIG. 11, side walls of spinner-type processing units (COT) and (DEV) facing the main arm mechanism 16 are provided with openings DR through which the wafer W and the transfer arm pass in/out. Each opening DR is equipped with a shutter (not shown) to prevent particles from entering the main arm mechanism 16 side from each unit.

The air conditioner 121 controls the air quantity supplied to the transfer chamber 21 and the air quantity exhausted therefrom, whereby the inside pressure of the transfer chamber 21 is set higher than that of the clean room. This prevents formation of air flows from the inside of the clean room or the cassette CR toward the transfer chamber 21, with the result that particles never enter the transfer chamber 21. Further, the inside pressure of the processing section 12 is set much higher than that of the transfer chamber 21. This prevents formation of air flows from the transfer chamber 21 toward the processing section 12, with the result that particles never enter the processing section 12.

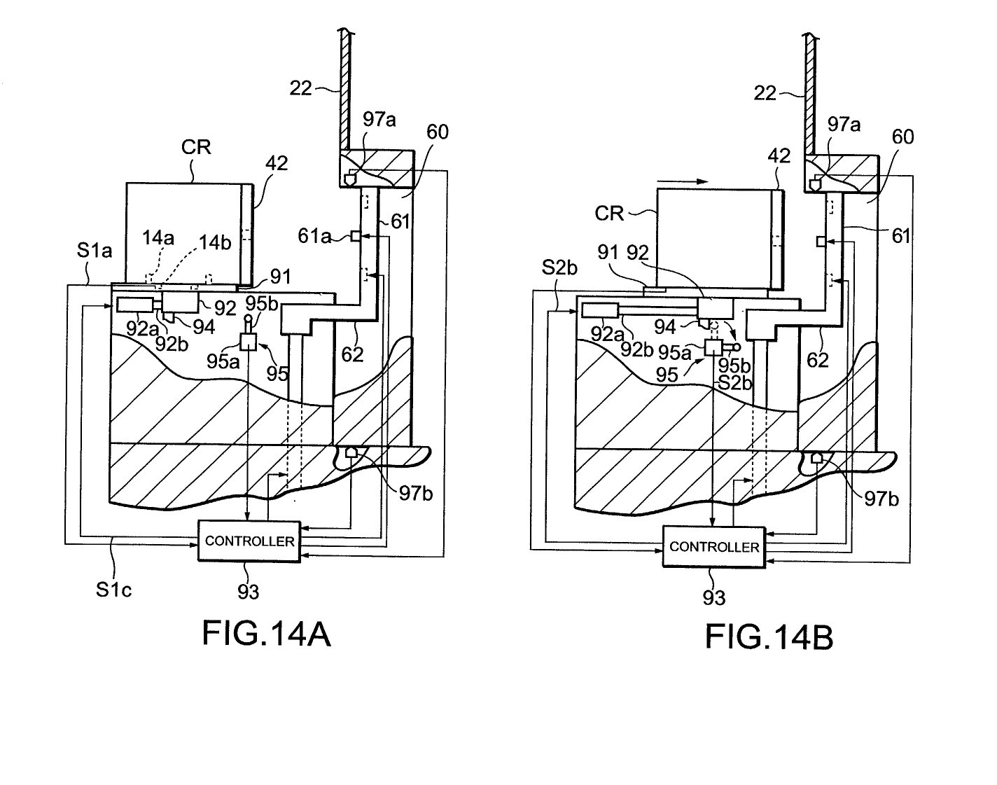

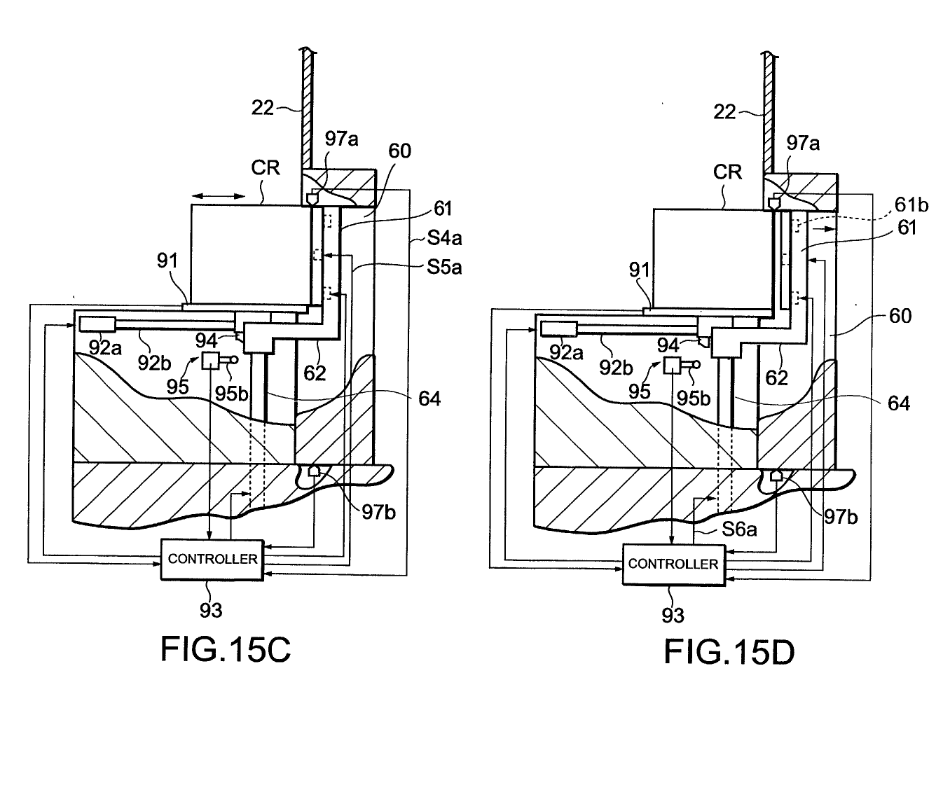

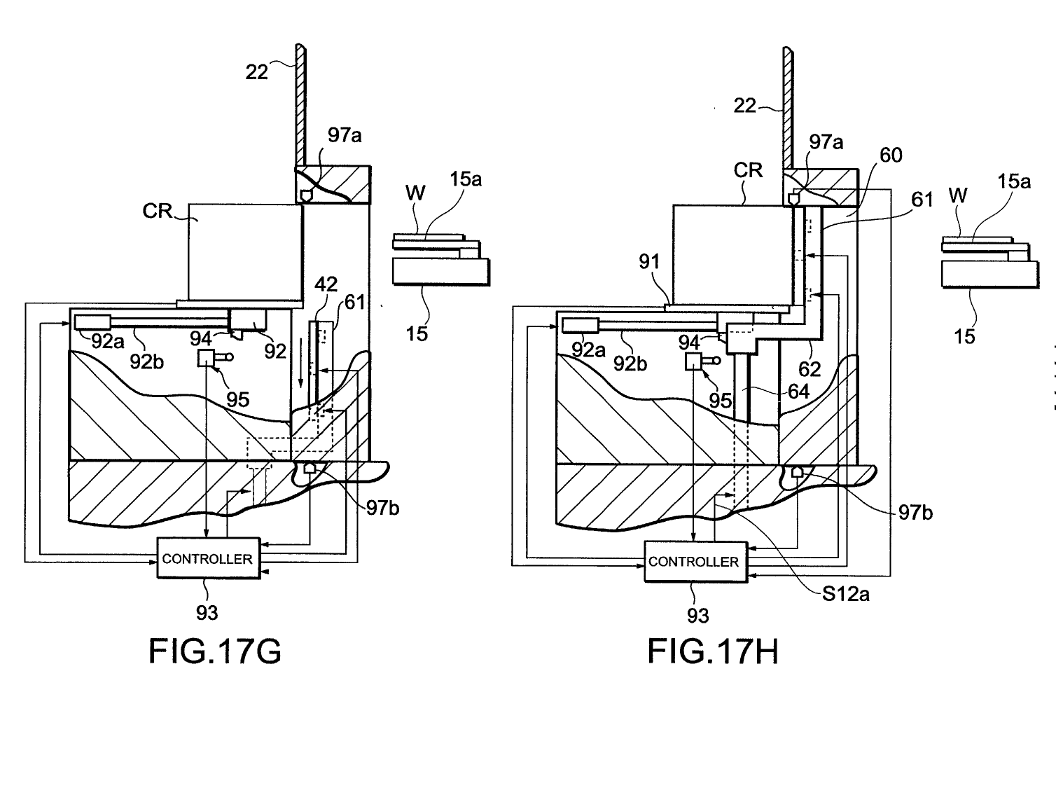

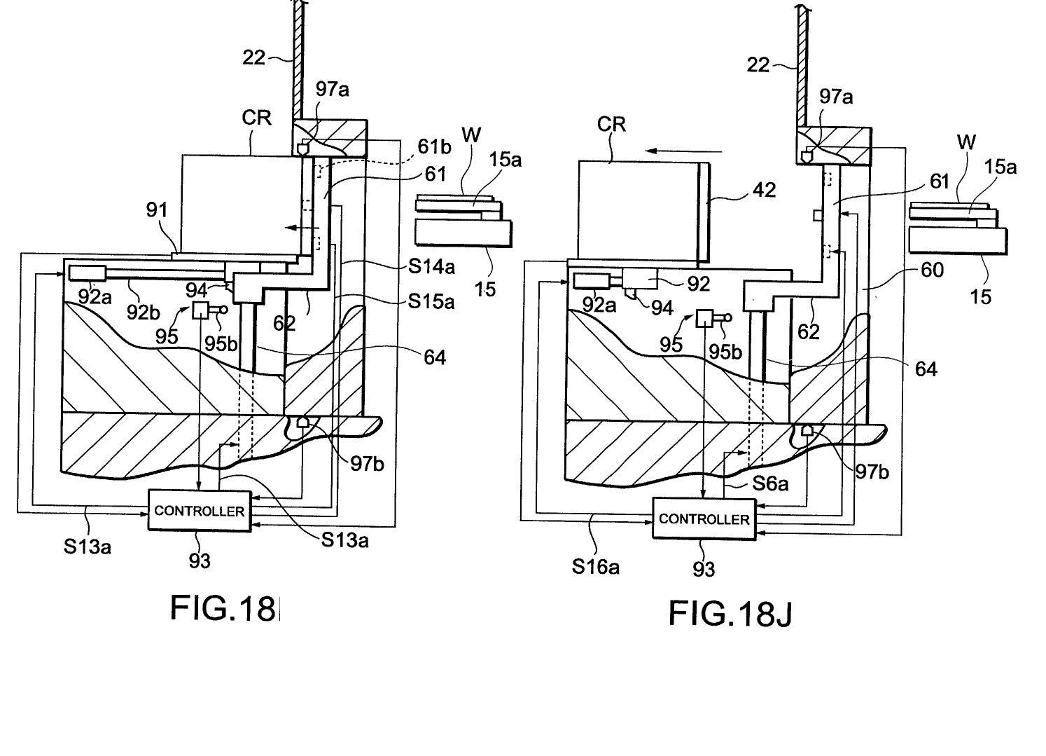

As shown in FIG. 14A, the initial position of the cassette CR when it is placed on the mounting table 14 and positioned is called “the first position.” The position of the cassette CR when the lid 42 is removed from the cassette CR or attached thereto as shown in FIG. 15C and FIG. 18I, and the position of the cassette CR when the wafer W is taken out of the cassette CR from which the lid 42 has been removed as shown in FIGS. 17G and 17H is called “the third position.” Whether or not the cassette CR is at the first position is determined by the controller 93 based on the detection information sent from the sensors 14b. Further, the optical sensors 97a and 97b detect the wafer W protruding from the cassette CR to prevent the retreated lid 42 of the cassette CR from interfering with a protruding wafer W when the lid 42 ascends.

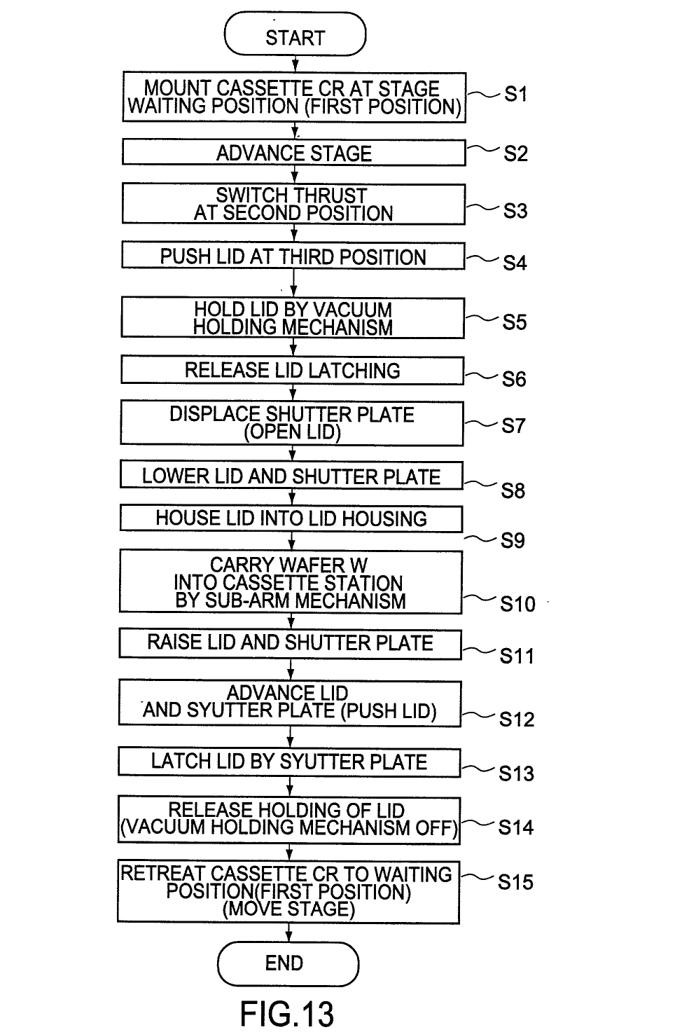

Next, the operation of the lid removing mechanism 24 is explained along the flowchart in FIG. 13 referring to FIG. 13 to FIG. 19.

Before the cassette CR is mounted on the mounting table 14, the shutter plate 61 of the lid removing mechanism 24 is located in the path (tunnel) 23a as shown in FIG. 9. This allows the shutter plate 61 to close the opening 23a which is provided in the first vertical partition plate 22, thereby blocking the atmosphere in the transfer chamber 21 from the clean room atmosphere.

As shown in FIG. 14A, when the cassette CR is placed on the slide stage 91, the projections 14a fit in the bottom recesses (not shown) of the cassette CR, whereby the cassette CR is positioned at the first position (Si). Then, signals S1a each presenting a cassette transfer start operation are inputted into the controller 93 from the sensors 14b which function as touch sensors. When the signals S1a are inputted into the controller 93, the controller 93 outputs an air supply command signal to the air supply source 202 and a port switching signal to the solenoid drive 204. This operates the solenoid valve 206 and the pressure control valve 208 respectively, supplying a low pressure air through the line 229 to the one inner chamber of the X-axis cylinder 92a, whereby the cassette CR starts advancing with the slide stage 91 by a low thrust of, for example, 9N (S2).

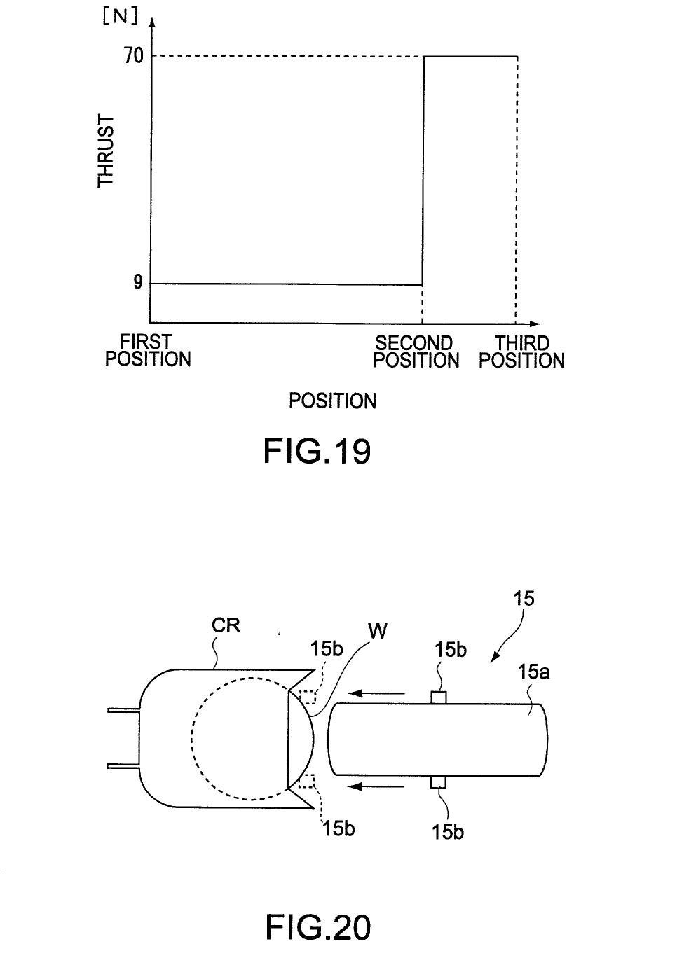

As shown in FIG. 14B, when the cassette CR reaches the second position from the first position as the slide stage 91 moves by the thrust of 9N, the switching drive piece 94 contacts the switching lever 95b of the thrust switching mechanical valve 95. This tilts the switching lever 95b to switch the mechanical valve 95. Thereby, a thrust increasing signal S2b for increasing the thrust to 70N is inputted into the X-axis cylinder 92a. Concretely, the circuit of the switching valve 95a shown in FIG. 6 switches to open the line 221. This causes the slide head of the pressure switching valve 212 to move downward, blocking the line 224 and opening the other line 226, thereby supplying a high pressure air through the line 226 into the one inner chamber of the cylinder 92a to advance the cassette CR by a strong thrust (S3 in FIG. 13). Accordingly, the cassette CR is pushed by the strong thrust from a distance where the finger of the operator is scarcely caught, thereby preventing particles from entering the apparatus and preventing the finger of the operator from being caught and making for greater safety. FIG. 19 is a view showing the relation between the position of the cassette CR in the X-axis direction and the thrust of the X-axis cylinder 92a. It should be noted that the thrust from the first position to the second position is 9N, but, not limited to this, it is preferably about 5 N to about 15N. The thrust from the second position to the third position is 70N, but, not limited to this, it is preferable 20N to 100N.

The cassette CR advances to the third position by the thrust of 70N, thereby pushing the cassette lid 42 against the shutter plate 61 (S4). The state of pushing the cassette lid 42 is shown in FIG. 15C.

Whether or not the cassette lid 42 is pushed against the shutter plate 61 is determined by the touch sensors 97a and 97b detecting the cassette lid 42 advancing. When the touch sensors 97a and 97b detect the cassette CR advancing to the third position, they output detection signals S4a to the controller 93. The controller 93 receives the detection signals S4a and then outputs a signal S4b to a vacuum holder 61 b. When receiving the signal S4b, the vacuum holder 61 b holds the cassette lid 42 by vacuum suction (S5). Though the case in which the detection of the position and the suction-holding of the lid 42 are performed based on the detection signals of the sensors 97a and 97b is shown, the suction-holding of the lid 42 may be performed through detection of a docking signal by another sensor (not shown).

In this state, the cassette lid 42 and the shutter plate 61 are united, and the keys 61a are inserted into the key holes 43. When the cassette lid 42 is held by the shutter plate 61, the controller 93 then outputs signals S5a to the keys 61a. When receiving the signals S5a, the keys 61a rotate in the θ′-direction, the shutter plate 61 is locked to the cassette lid 42, and latching of the cassette lid 42 to the cassette CR is released (S6).

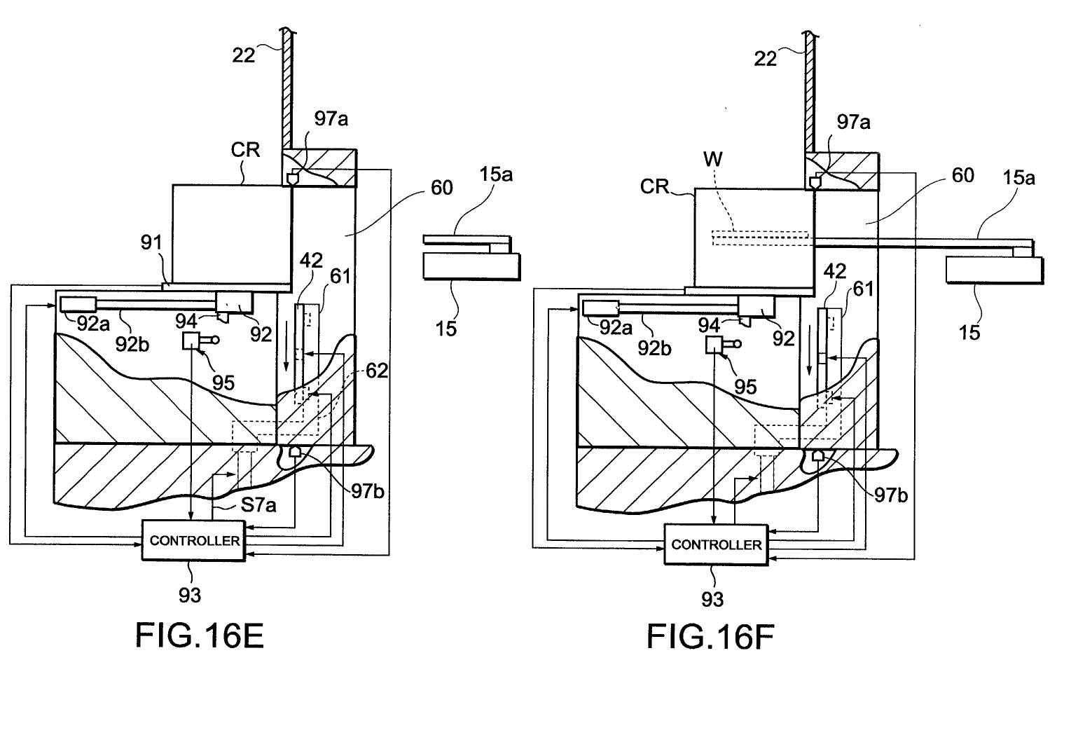

As shown in FIG. 15D, the controller 93 outputs a retreating signal S6a to the X-axis drive mechanism (not shown) of the shutter plate 61 to retreat the shutter plate 61, thereby parting the cassette lid 42 from the cassette CR (S7). Subsequently, as shown in FIG. 16E, the controller 93 outputs a lowering signal S7a to the raising and lowering mechanism 64 to lower the lid 42 with the shutter plate 61 (S8) to house the lid 42 into the housing chamber (lower opening) 23b (S9).

Since the third position is in the path (tunnel) 23a, the inside of the cassette CR communicates with the inner atmosphere of the processing system 1. Further, the atmosphere inside the transfer chamber 21 is blocked from the clean room atmosphere by the cassette CR, thereby preventing particles from entering the processing system 1 through the path 23a. Further, because of installation of a cassette hook (not shown) at the center of the slide stage 91, the cassette CR can not be lifted from the mounting table 14 during the processing. This can prevent an accident that the operator lifts the cassette during the processing by mistake to cause suspension of the processing.

As shown in FIG. 16F, the arm 15a of the first sub-arm mechanism 15 is inserted into the cassette CR to take the wafer W out of the cassette CR (S10). As shown in FIG. 20, a pair of mapping sensors 15b are movably attached on the arm 15a of the first sub-arm mechanism 15. These sensors 15b are configured to move to the tip of the arm 15a for mapping operations. Therefore, if there exists a wafer W protruding from the cassette CR, the sensor 15b hits the protruding wafer W to cause malfunction of the mapping and damage the wafer W. In order to eliminate mutual interference between the protruding wafer W and the sensors 15b, when the optical sensors 97a and 97b detect the wafer W protruding from the cassette CR, the controller 93 which receives the detection signals gives an alarm and stops the mapping operation. The operator checks the wafer W in the cassette CR and corrects the position of the wafer W in the cassette CR. Then, the operator pushes a reset button to resume the processing operation.

The wafer W is carried from the cassette station 11 into the processing section 12 and processed in each of the units of the processing section 12, and further subjected to exposure processing in the aligner and , after the processing, the wafer W is returned again to the cassette CR in the cassette station 11.

As described above, after completion of the processing for all the wafers W in the cassette CR, as shown in FIG. 17H, the controller 93 outputs a raising signal S12a to the raising and lowering mechanism 64 to raise the lid 42 with the shutter plate 61 (S11). Then, as shown in FIG. 18I, the controller 93 outputs an advance signal S13a to the X-axis drive mechanism (not shown) to advance the shutter plate 61 (S12). This causes the lid 42 to fit in the opening of the cassette CR.

Further, locking signals S14a are outputted to the keys 61a to rotate the keys 61a, thereby releasing the locking between the shutter plate 61 and the lid 42 and locking the keys 61a (S13). Then, the controller 93 outputs a suction stop signal S15a to the vacuum holder 61 b to stop the vacuum suction, thereby releasing the holding of the lid 42 (S14).

As shown in FIG. 18J, the controller 93 outputs a retreat signal S16a to the X-axis cylinder 92a. Concretely, the controller 93 outputs an undocking command signal to the solenoid drive 204 to open another port of the solenoid valve 206. Concretely, the port switching signal switches on the solenoid 206b. This supplies air through the line 236 to the other inner chamber of the cylinder 92a, whereby the cassette CR retreats to leave the system 1. Then, the cassette CR retreats from the third position to the first position (S15). As the slide stage 91 returns to the first position, the pressurized air is supplied to the port of the lever switching valve 95, thereby returning the lever 95b from the tilted attitude to the standing attitude. Then the cassette CR is carried out of the cassette station 11. The return of the lever 95b from the tilted attitude to the standing attitude may be conducted by resilience of a spring or the like for the standing attitude.

With the above-described apparatus, the shutter plate 61 blocks the path 23a during non-processing, and the cassette CR blocks the path 23a during the processing, thereby making it difficult for particles to enter the system from the clean room.

Further, the wafer W is taken into/out of the cassette CR with the front end of the cassette CR inserted into the path 23a, thereby completely preventing a trouble that the operator lifts the cassette CR during the processing from the mounting table 14 by mistake.

Furthermore, the thrust is decreased during the advance of the cassette CR to the position where there is a risk that the finger of the operator is caught, and the thrust is increased at the position where there is no more risk. Consequently, the cassette CR is transferred with the thrust held at less than a predetermined value to the position where there is a risk that the finger or the like can be caught, and the risk of the finger being caught decreases.

### Second Embodiment

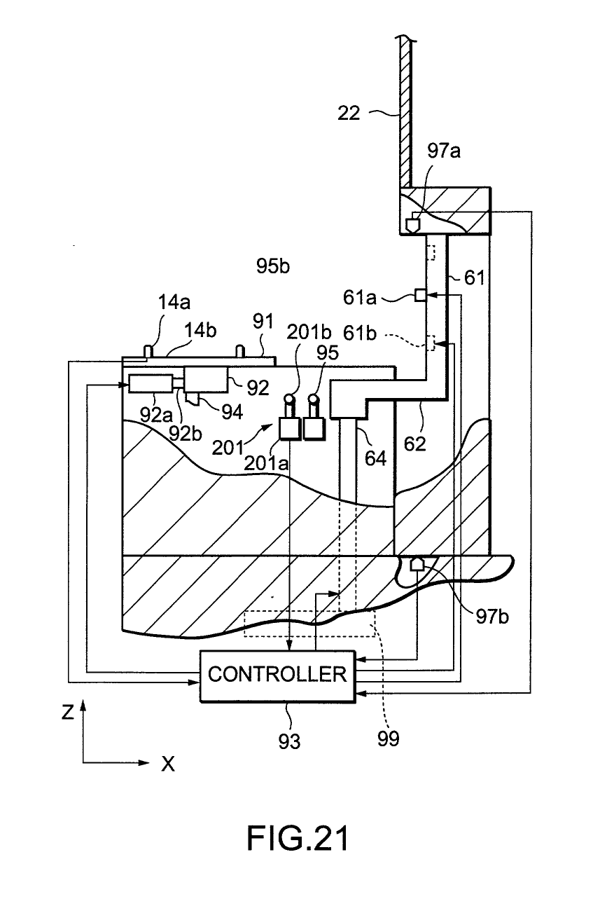

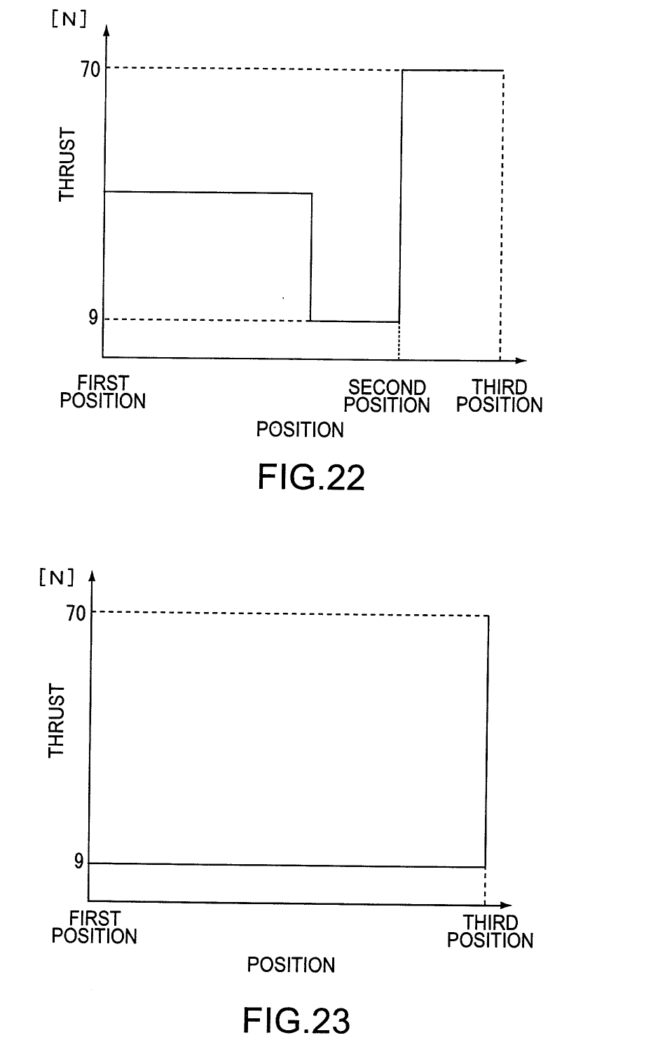

FIG. 21 and FIG. 22 are views for explaining a substrate processing apparatus according to the second embodiment of the present invention. Incidentally, the description on portions of the second embodiment in common with those in the above-described first embodiment is omitted and the same numerals are given to the same components.

FIG. 21 is a perspective cross-sectional view showing the cassette removing mechanism by cutting off apart of the cassette station of the substrate processing apparatus according to this embodiment. The point different from the first embodiment is that a thrust switching mechanical valve 201 is further provided a long the moving route of the movable base 92 and remote from the vertical partition plate 22 with respect to the arrangement position of the thrust switching mechanical valve 95. The thrust switching mechanical valve 201 comprises, similarly to the thrust switching mechanical valve 95, a lever switching valve 201a and a switching lever 201 b, so that the switching lever 201 b is switched when the drive piece 94 reaches a predetermined position by its linear movement in the X-axis direction. The predetermined position here is a position where the space between the lid 42 of the cassette CR and the vertical partition plate 22 is about 20 mm to about 50 mm or, more preferably, about 25 mm to about 30 mm. This is a distance at which even if the finger of the operator is caught in the space between the lid 42 and the vertical partition plate 22, the finger can be pulled out, the width of the space can be changed as required in accordance with using conditions or the like.

The relation between the position of the cassette CR in the X-axis direction and its thrust when the two thrust switching mechanical valve s 95 and 201 are thus arranged is shown in FIG. 22.

As shown in FIG. 22, the operation after the thrust is switched by the thrust switching mechanical valve 95 is the same as that in FIG. 19 of the first embodiment. In this embodiment, the thrust is increased to, for example, 40N until the cassette CR approaches to the vertical partition plate 22 to a distance where even if the finger or the like of the operator is caught therebetween, the finger can be pulled out, and the thrust after the switching by the mechanical valve 201 is decreased to 9N. Then, the mechanical valve 95 operates at a position where the finger of the operator can not be caught, for example, 10 mm to 15 mm (the second position) from the vertical partition plate 22, allowing the cassette CR to contact the partition plate 22 by a thrust of 70N. Accordingly, it is possible to further increase the safety of the operation and to further increase the accuracy of the removal of the cassette lid 42 by the shutter plate 61. Further, since the stage 91 advances by a high thrust from a position as close as that a finger or the like can no longer be caught, the period of time necessary for the operation until the cassette CR is carried in can be made short. It should be noted that the thrust before the switching by the mechanical valve 201 is 40N, but, not limited to this, it is preferable 20N to 100N. Further, the thrust from the switching by the mechanical valve 201 to the second position is 9N, but, not limited to this, it is preferably about 5N to about 15N. Furthermore, the thrust from the second position to the third position is 70N, but, not limited to this, it is preferable 20N to 100N.

The present invention is not limited to the above-described embodiments. A modification of the present invention is shown in FIG. 23. FIG. 23 is a view showing the relation between the position of the cassette CR in the X-axis direction and the thrust applied to the X-axis cylinder 92a. The remaining configuration is the same as that of the first embodiment. The different point from the first embodiment is that the thrust is increased at a position where the cassette CR contacts the shutter plate 61. This pushes the cassette CR against the shutter plate 61 by a sufficient force, thereby increasing the safety of the operation, and setting the thrust within a region where the finger of the operator might be caught regardless of the force of pushing against the shutter plate 61. Therefore, the safety of the operation can be further increased. The case shown in FIG. 23 requires no mechanical valve 95.

The lid removing mechanism shown in the embodiment is, of course, applicable to an apparatus other than the above-described coating and developing system. That is, it is applicable to all cases when a wafer W is carried in/out between two regions which are desired to be blocked through an opening, for example, when the it is carried from the clean room into the cassette station, when it is carried into/from the clean room from/into another processing chamber, when it is carried in/out between two processing chambers, and the like.

Furthermore, various changes may be made therein without departing from the spirit of the present invention.

Though the wafer is used as a substrate in the embodiment, a substrate other than this, for example, an LCD substrate or the like is similarly applicable.

Further, the cassette CR closes the opening 23a which is provided in the vertical partition plate 22 to block the atmosphere in the processing system 1 from the clean room atmosphere during the processing in this embodiment, but, it is not always necessary to do this in such a manner. Only a positive pressure to the clean room atmosphere which is formed by the down flows in the processing system 1 can prevent particles and the like from entering the processing system 1 from the clean room atmosphere. The switching drive piece 94 is provided on the lower face of the movable base 92, but it may be provided on any component, such as the slide stage 91 or the like, so far as it moves in the X-axis direction with the cassette CR when the cassette CR is moved in the X-axis direction.

Further, the lid removing mechanism is not limited to the above-described configuration. For example, it is possible to employ a lid removing mechanism that is driven using a cylinder, or one that can be driven not only in the Z-axis direction but also in the Y-axis direction. Moreover, the lid removing mechanism may rotate around the X-axis to move from a lid-removing position to a lid-housing position. Other than that , any configuration is employable that is movable from the lid-removing position to the lid-housing position.

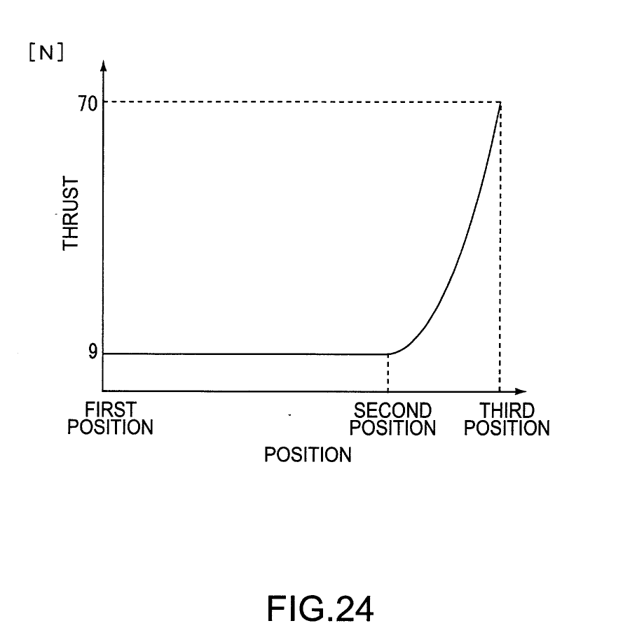

Further, the case in which the thrust is changed in steps at least at two levels is shown in the above-described embodiment, but the change is not limited to this. The thrust may be changed, for example, in sequence or in steps at three or four levels as shown in FIG. 24 so far as it maintained a predetermined thrust at a position closer to the transfer chamber 21 than the second position.

Whether or not the cassette CR is located at the third position is detected by the optical sensors 97a and 97b, but it is not necessary to provide these optical sensors 97a and 97b.

Further, as for the lid-removing operation, the case is shown in which the shutter plate 61 is retreated from the lid-removing position to remove the lid 42, but it is not limited to this. For example, the lid 42 is moved in the Z-axis direction and housed in the lid housing 23b with the cassette CR retreated from the lid-removing position and located a part from the opening 23a slightly farther than the third position. In this case, it is preferable to provide other optical sensors at the top and the bottom of the gate block 60 in a row with the optical sensors 97a and 97b so that their optical axes cross the front end of the cassette CR when the lid 42 thereof is housed. These other optical sensors can detect the fact that the cassette CR is located at a position apart from the opening 23a.

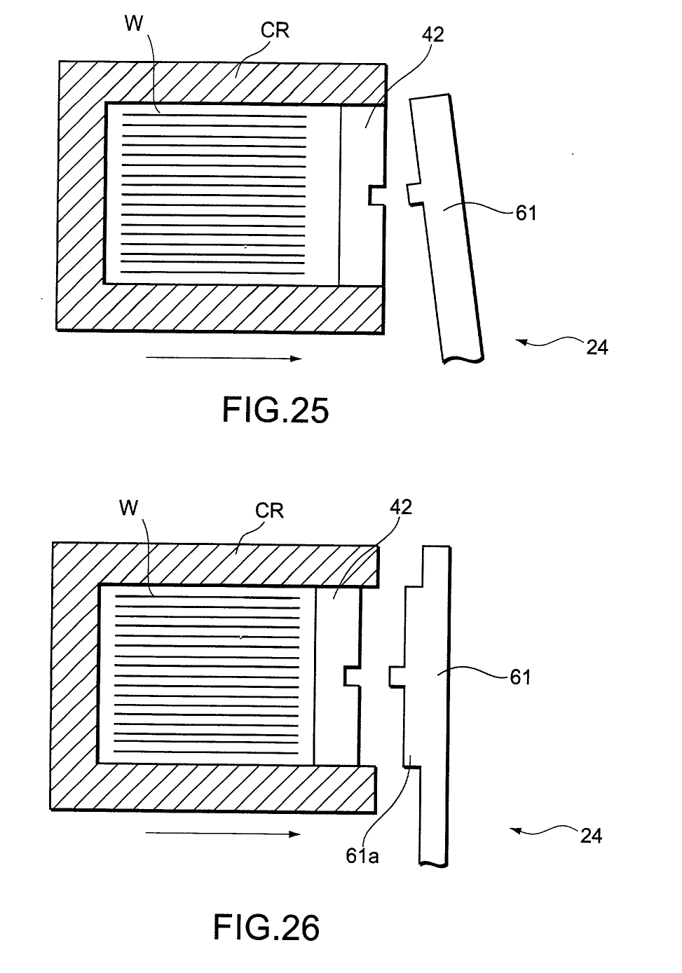

As shown in FIG. 25, the shutter plate 61 of the lid removing mechanism 24 may be inclined. Concretely, the shutter plate 61 of the lid removing mechanism 24 usually face s the lid 42 which is attached to the cassette CR to be parallel to the lid 42, but the shutter plate 61 may be inclined in such a manner that a space between the shutter plate 61 and the lid 42 becomes narrower upwardly. For example, the shutter plate 61 is inclined to produce a difference of about 5 mm between the top and the bottom of the space between the shutter plate 61 and the lid 42. Since the shutter plate 61 is supported at the bottom, such inclination of the shutter plate 61 in such a manner that the space between the shutter plate 61 and the lid 42 becomes narrower upwardly results in a uniform application of a force from the shutter plate 61 to the lid 42 when the shutter plate 61 contacts the lid 42. This causes close contact between the shutter plate 61 and the lid 42, thereby making it possible to conduct open and close operations by turning the keys 61a, and to insert and pull out the keys 61a smoothly.

Further, as shown in FIG. 26, the lid 42 is arranged to be attachable and detachable at a position inside by about 1 mm, for example, from the opening of the cassette CR, and a projection 61a is provided on the shutter plate 61 to cope with the arrangement. The projection 61a is inserted into the cassette CR when the shutter plate 61 contacts the lid 42. This results in that when the shutter plate 61 contacts the lid 42, a force is uniformly applied from the shutter plate 61 to the lid 42, allowing the shutter plate 61 to closely contact the lid 42, thereby making it possible to conduct open and close operations by turning the keys 61a, and to insert and pull out the keys 61a smoothly.

Further, the thrust of the cassette CR side is controlled in the above-described embodiment, but the thrust of the lid removing mechanism 24 may be controlled. For example, the thrust of the lid removing mechanism 24 may be controlled by, for example, the X-axis drive mechanism 99 between the second position and the third position.

As has been described, according to the present invention, when the wafer is carried into the processing system, it is possible to prevent a finger or the like from being caught between the cassette and the partition plate and to carry in the wafer with certainty and safety.

The disclosure of Japanese Patent Application No.2000-181806 filed Jun. 16, 2000 including specification, drawings and claims are herein incorporated by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A substrate processing apparatus, comprising:
a cassette mounting table for mounting thereon a cassette having an opening for carrying in/out a substrate and including a lid detachably attached on the opening;
a processing section for processing the substrate housed in the cassette on the cassette mounting table;
a transfer arm mechanism for taking the substrate out of the cassette on the cassette mounting table, transferring the substrate to the processing section, and returning the substrate after processing to the cassette on the cassette mounting table;
a partition member, provided between the transfer arm mechanism and the cassette mounting table, for partitioning an atmosphere on the transfer arm mechanism side from an atmosphere on the cassette mounting table side, and including an opening larger than the opening of the cassette;
a cassette transfer mechanism disposed to be movable forward and backward in a direction of the opening of the partition member;
a lid removing mechanism for removing the lid from the opening of the cassette through the opening of the partition member and attaching the lid to the opening of the cassette; and
a thrust control mechanism for changing a thrust of the cassette transfer mechanism before and after the cassette reaches the partition member with a predetermined space interposed therebetween.

2. The apparatus as set forth in claim 1,
wherein the thrust control mechanism conducts a control to decrease the thrust of the cassette transfer mechanism where the cassette on the cassette transfer mechanism is apart from the partition member by a predetermined distance or more, and to increase the thrust of the cassette transfer mechanism where the cassette on the cassette transfer mechanism is apart from the partition member by less than the predetermined distance.

3. The apparatus as set forth in claim 2,
wherein a first thrust of the cassette transfer mechanism is about 5N to about 15N where the cassette is apart from the partition member by the predetermined distance or more, and a second thrust of the cassette transfer mechanism is 20N to 100N where the cassette is apart from the partition member by less than the predetermined distance.

4. The apparatus as set forth in claim 3,
wherein the first thrust is 9N, and the second thrust is 70N.

5. The apparatus as set forth in claim 1, further comprising:
a thrust switching mechanism, fixedly disposed on the cassette mounting table along a moving route of the cassette transfer mechanism, for outputting to the thrust control mechanism a signal for switching the thrust of the cassette transfer mechanism by contacting a part of the cassette transfer mechanism with the thrust switching mechanism at a predetermined position.

6. The apparatus as set forth in claim 1,
wherein the cassette transfer mechanism is driven by an air pressure cylinder.

7. The apparatus as set forth in claim 6,
wherein the air pressure cylinder is provided with a mechanism having at least two levels of thrusts in a direction in which the cassette advances to the partition member, and having at least one thrust in a direction in which the cassette retreats from the partition member.

8. The apparatus as set forth in claim 1,
wherein the lid removing mechanism including a shutter plate for contacting the lid of the cassette, and
wherein the shutter plate is inclined with respect to the lid.

9. The apparatus as set forth in claim 8,
wherein the lid removing mechanism includes a supporter for supporting the shutter plate in a cantilever manner, and
wherein the shutter plate is supported inclined with respect to the lid by the supporter so that a space between the shutter plate and the lid decreases as it becomes apart from the supporter.

10. The apparatus as set forth in claim 1,
wherein the lid is attachable and detachable at a position inside from an opening of the cassette, and
wherein the lid removing mechanism includes a shutter plate having a projection which is inserted into the opening of the cassette to contact the lid.

11. The apparatus as set forth in claim 2,
wherein a first thrust of the cassette transfer mechanism is fixed where the cassette is apart from the partition member by the predetermined distance or more, and a second thrust of the cassette transfer mechanism gradually increases where the cassette is apart from the partition member by less than the predetermined distance.

12. A substrate processing apparatus, comprising:
a cassette mounting table for mounting thereon a cassette having an opening for carrying in/out a substrate and including a lid detachably attached on the opening;
a processing section for processing the substrate housed in the cassette on the cassette mounting table;
a transfer arm mechanism for taking the substrate out of the cassette on the cassette mounting table, transferring the substrate to the processing section, and returning the substrate after processing to the cassette on the cassette mounting table;
a partition member, provided between the transfer arm mechanism and the cassette mounting table, for partitioning an atmosphere on the transfer arm mechanism side from an atmosphere on the cassette mounting table side, and including an opening larger than the opening of the cassette;
a cassette transfer mechanism disposed to be movable forward and backward in a direction of the opening of the partition member;
a lid removing mechanism, disposed to be movable forward and backward in the direction of the opening of the partition member, for removing the lid from the opening of the cassette through the opening of the partition member and attaching the lid to the opening of the cassette; and
a thrust control mechanism for changing at least either a thrust of the cassette transfer mechanism or the lid removing mechanism before and after the cassette reaches the partition member with a predetermined space interposed therebetween.

13. The apparatus as set forth in claim 12,
wherein the thrust of the cassette removing mechanism is changed where the cassette is apart from the partition member by less than a predetermined distance.
